(19) United States
(12) Patent Application Publication
(10) Pub. No.: US 2008/0071948 A1
(43) Pub. Date: Mar. 20, 2008

(54) Programmable interface for single and multiple host use

(75) Inventors: Robert James, San Jose, CA (US); David Carr, Ontario (CA)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: Integrated Device Technology, Inc.

(21) Appl. No.: 11/522,173

(22) Filed: Sep. 14, 2006

(51) Int. Cl. G06F 13/38

(52) U.S. Cl. 710/62

(57) ABSTRACT

A serial interface including a controller, a first unit interface, and a second unit interface. The first unit interface communicatively couples the controller with a host, wherein the first unit interface communicates with the host through a first set of lanes. The second unit interface communicatively couples the controller with the host, wherein the second unit interface communicates with the host through a second set of lanes, wherein the controller bonds the first unit interface and the second unit interface to function as a single entity for communicating with the host.

### CROSS REFERENCE TO RELATED APPLICATIONS

This application relates to the following co-pending, commonly owned applications: “Method for Improved Efficiency and Data Alignment in Data Communications Protocol” having attorney docket number 9145.0028-00 and “Method for Deterministic Timed Transfer of Data with Memory Using a Serial Interface” with attorney docket number 9145.0029-00, both of which are incorporated in their entirety by reference.

### DESCRIPTION OF THE INVENTION

1. Field of the Invention

The present invention relates to integrated circuits, and in particular, to communication between integrated circuits.

2. Discussion of Related Art

Modern networking systems allow users to obtain information from multiple data sources. These data sources may include, for example, publicly accessible web pages on the Internet as well as privately maintained and controlled databases. Users may access data from the data sources by entering certain identifying information. For example, a user on the Internet may access data on a website by entering the domain name of the website, where the domain name serves as the identifying information. Similarly, a user of a corporate database may access personnel data about a company employee by entering the last name of the employee, where the last name serves as identifying information. In some instances, a network search engine (“NSE”) may facilitate the process of looking-up the location of the requested data.

For example, a router may receive communications from a network and provide this information to a first integrated circuit (“IC”), such as an application-specific IC (“ASIC”). The ASIC then provides the identifying information to the NSE, which may be implemented by a second IC, to determine the location in the memory of the requested data. After determining the location of the data, the NSE may request that the memory provides the requested data to the ASIC while also informing the ASIC that the requested data is being sent by the memory. In many networking systems, the NSE is mounted to the same printed circuit board (“PCB”) as the ASIC with the traces of the PCB connecting the two components. Although some networking systems may substitute a network processing unit (“NPU”) or a field programmable gate array (“FPGA”) for the ASIC in this description, the roles of the respective components remain the same. Thus, in some networking systems, the NPU or FPGA may accept communications from the network and provide the identifying information to the NSE, which may facilitate delivering the requested data to the NPU or FPGA.

In some networking systems, communication between the NSE and the ASIC occur using parallel bus architecture on a printed circuit board. Initially, bi-directional parallel buses were used in which an IC used the same pins to both send and receive information. As data rates between the NSE and ASIC increased, networking systems began to be implemented using uni-directional parallel buses in which the ICs used each pin to either send or receive data, but not both. To accommodate the amount of data being transmitted between the ASIC and the NSE, some current networking systems use an 80-bit bus on the printed circuit board to connect the ASIC and NSE. Issues have arisen, though, with using the parallel bus architecture to connect the ASIC and the NSE. For example, using an 80-bit bus complicates the design and layout process of the printed circuit board. Additionally, increasing processing and communication speeds have exposed other limitations with the parallel bus architecture. For example, the data transmitted by a parallel bus should be synchronized, but as communication speeds have increased, the ability to synchronize data transmitted on a parallel bus has become problematic. Further, it is difficult to route wide busses because traces should be kept short and equal length to avoid skewing. Because of the short distance, the NSE must be located close to the ASIC, resulting in many hot chips being located close together. This close placement creates thermal issues on the printed circuit board.

In response to the issues posed by using a parallel bus, some networking devices connect the ASCI and NSE with a high speed serial bus. Further, the networking device may use a serializer-deserializer (“SERDES”) to allow the ASIC and NSE to continue using a parallel interface to communicate with each other. For example, when the ASIC communicates with the NSE, a SERDES may convert the parallel output from the ASIC, converting it to a serial data stream to be transmitted to the NSE. Another SERDES may receive this serial transmission and convert it to a parallel data stream to be processed by the NSE. As a result, instead of transmitting data over an 80-bit parallel bus at 250 MHz Double Data Rate (40 Gbps), networking devices could transmit data over 8 serial lanes operating at 6.25 Gbps. Despite this increase in data transmission rates as compared to systems using parallel bus architecture, increasing clock speeds and data transmission rates may require developers of networking devices to seek additional methods for increasing the transmission rates between the ASIC and the NSE.

Because of the dependence of the networking system on NSE and the ASIC, the faster the NSE and ASIC can communicate with one another, the higher the throughput of the networking system and lower the latency.

### SUMMARY OF THE INVENTION

In accordance with the present invention, a serial interface is presented. The serial interface includes a controller and multiple unit interfaces that communicatively couple the controller with at least one host, wherein a set of lanes couples each unit interface communicates with the host. The controller has the ability to bond two or more unit interfaces to function as a single entity when the two or more unit interfaces communicate with a single host. In some embodiments, the serial interface can include a search engine interface that communicatively couples the controller to a network search engine.

In accordance with the present invention, a method of using a serial interface is presented. The method includes receiving request packets through multiple unit interfaces over multiple set of lanes from at least one host, wherein each unit interface corresponds to a single set of lanes, determining whether the received request packets are aligned, and bonding multiple unit interfaces to function as a single entity based on the determination and whether the received request packets received through the multiple set of lanes corresponding to the multiple unit interfaces are from a single host. In some embodiments, the method may include adjusting the alignment of the multiple unit interfaces based on the determination that the received request packets are not aligned. In some embodiments, the method may further include transmitting subsequent response packets through multiple unit interfaces over multiple set of lanes to at the at least one host, and receiving subsequent requests packets through the multiple set of lanes through the at least one host for determining whether the subsequent response packets are aligned for bonding the multiple unit interfaces.

In accordance with the present invention, a system is presented. The system includes at least one host, a NSE, and a serial interface configured to translate the data communicated between the host and the network search engine. The serial interface includes a controller, and multiple unit interfaces that communicatively couple the controller with at least one host, wherein a set of lanes couples each unit interface with a host. The controller has the ability to bond two or more unit interfaces to function as a single entity when the two or more unit interfaces communicate with a single host.

In accordance with the present invention, a serial interface is presented. The serial interface includes a controller, a first unit interface that communicatively couples the controller with a host, wherein the first unit interface communicates with the host through a first set of lanes, and a second unit interface that communicatively couples the controller with the host, wherein the second unit interface communicates with the host through a second set of lanes. The controller has the ability to bond the first unit interface and the second unit interface to function as a single entity for communicating with the host. In some embodiments, the controller has the ability to bond the first unit interface and the second unit interface based on communication with a configuration interface. Further, in some embodiments, the controller has the ability to bond the first unit interface and the second unit interface based on communication with a serial receive unit. Furthermore, in some embodiments, the controller has the ability to bond the first unit interface and the second unit interface based on communication with a serial transmit unit.

A more complete understanding of embodiments of the present invention will be appreciated by those skilled in the art, as well as a realization of additional advantages thereof, by a consideration of the following detailed description of one or more embodiments. Reference will be made to the appended drawing that will first be described briefly.

### BRIEF DESCRIPTION OF THE DRAWINGS

FIG. 1A shows a block diagram of an exemplary system according to some embodiments of the present invention.

FIGS. 1B-1E show exemplary configurations of a host and a plurality of peripheral devices.

FIG. 2 shows a block diagram illustrating an exemplary serial interface according to some embodiments of the present invention.

FIGS. 3, 4, & 5 illustrate exemplary embodiments of coupling one or more hosts to a serial interface of a network search engine according to some embodiments of the present invention.

FIG. 6 illustrates a flowchart providing an exemplary method for configuring the serial interface according to some embodiments of the present invention.

### DETAILED DESCRIPTION

Reference will now be made in detail to the exemplary embodiments implemented according to the invention, the examples of which are illustrated in the accompanying drawings. Wherever possible, the same reference numbers will be used throughout the drawings to refer to the same or like parts.

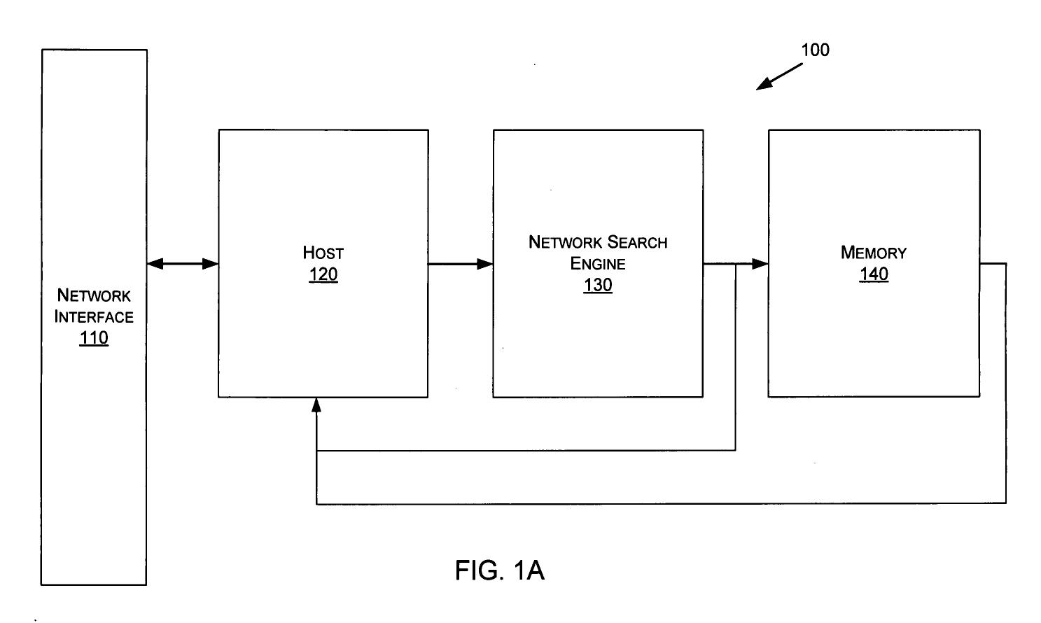

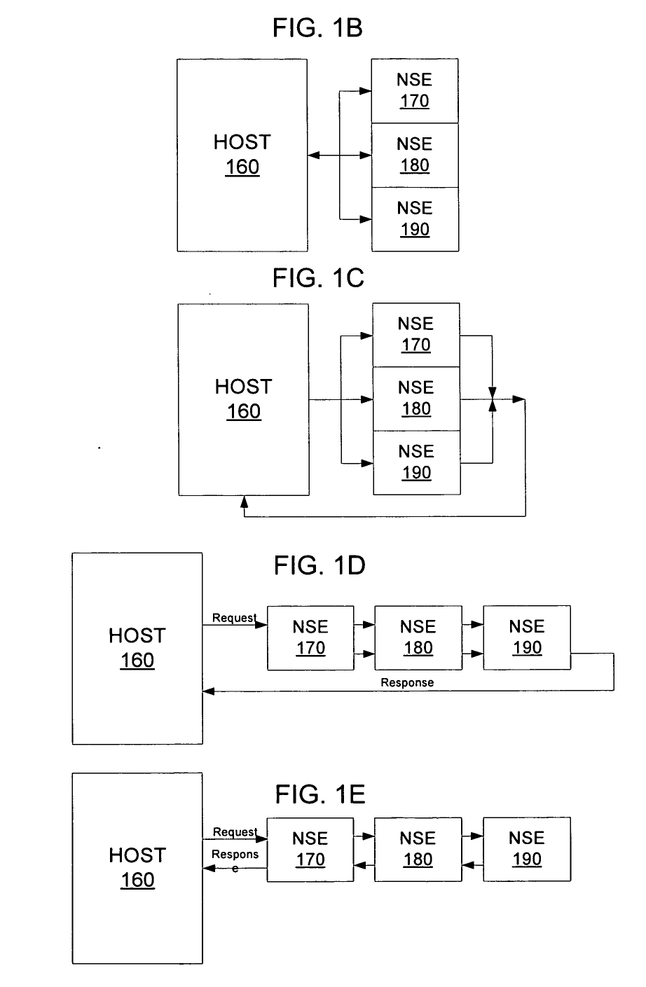

FIG. 1A is a block diagram of an exemplary system 100 according to some embodiments of the present invention. Exemplary system 100 can be any type of system that provides data searching. For example, exemplary system 100 can be utilized in a printed circuit board on a router, an enterprise switch, a storage area network (SANs), a Cable Modem Termination System (CMTS), or a Digital Subscriber Line Access Multiplexer (DSLAM). Further, exemplary system 100 can be utilized when the printed circuit board provides a connector, a serial interface, and a peripheral device (e.g., NSE) on a daughtercard, such as a Dual Inline Memory Module (DIMM) memory located in a PC. The exemplary system 100 can include, among other things, a network interface 110, a host 120, a network search engine (NSE) 130, and/or a memory 140.

Network interface 110 can be a software program and/or a hardware device that communicatively couples exemplary system 100 to the communication means (e.g. wireless and/or wired) connecting exemplary system 100 and the network. Network interface 110 is configured to receive data from the network, translate the data, and provide the data to the host 120 and vice versa.

Host 120 can be an integrated circuit configured to provide identifying data to NSE 130 and receive data corresponding to the identifying data from NSE 130. Host 120 can include one or more ports using one or more sets of serial lanes that can provide data to NSE 130 up to, for example, 10 Gbits/s. Host 120 can also receive data from memory 140 and/or NSE 130. In some embodiments, host 120 can be an ASIC, a NPU, or an FPGA.

NSE 130 can be a device that receives identifying data from host 120 and compares the data with all locations in its data memory array (not shown). If a match is found, NSE 130 can output the address to either host 120 or memory 140. The data memory array can be divided into 16 segments, each of which can be configured to be 72, 144, 288, or 576 bits wide. NSE 130 has the ability to perform a lookup within the data memory array for the identifying data. Once NSE 130 completes the lookup, NSE 130 can transmit an index to memory 140. NSE 130 can be provided on the same printed circuit board as host 120. For example, NSE 130 can be Integrated Device Technology Network Search Engine. In some embodiments, NSE 130 can include multiple NSEs coupled together though a parallel cascade shared request/response bus (FIG. 1B), a parallel cascade separate request/response bus (FIG. 1C), serial cascade separate request and response busses (FIGS. 1D & 1E).

Memory 140 can be a device that stores data until requested to do so by NSE 130. When memory 140 receives the index from NSE 130, memory 140 can supply the associated data to host 120. The associated data can include the next hop information quality of service, permit/deny decisions, or a multitude of other information that the host ASIC requires to forward (or block) the packet. For example, memory 140 can be an Integrated Device Technology Zero Bus Turnaround SRAM. In some embodiments, memory 140 can be deleted from exemplary system 100 and the result of the lookup at NSE 130 is provided to host 120, wherein the associated data memory is attached to the host ASIC directly.

FIG. 1B shows an exemplary configuration of a host and a plurality of peripheral devices. In this particular configuration, host 160 is connected to NSEs 170, 180, 190 through a parallel cascade shared request/response bus. This configuration allows for bi-directional communication on a single bus between the NSEs 170, 180, 190 and the host 160. For example, host 160 can be the same or similar to host 120 and NSEs 170, 180, 160 can be the same or similar to NSE 130.

FIG. 1C shows an exemplary configuration of a host and a plurality of peripheral devices. In this particular configuration, host 160 is connected to NSEs 170, 180, 190 through a parallel cascade separate request/response bus. This configuration allows a host 160 to transmit a request through a bus to the NSEs 170, 180, 190 and the NSEs 170, 180, 190 provide a response back to the host on a separate bus. This allows for unidirectional communication on a single bus between the NSEs and the host 160. For example, host 160 can be the same or similar to host 120 and NSEs 170, 180, 160 can be the same or similar to NSE 130.

FIG. 1D shows an exemplary configuration of a host and a plurality of peripheral devices. In this particular configuration, host 160 is connected to NSEs 170, 180, 190 through a serial cascade separate request and response busses. This configuration allows a host 160 to transmit a request through a bus to the NSEs 170, 180, 190, and the NSEs 170, 180, 190 provide a response back to the host 160 on a different communication medium. In this particular configuration, if host 160 sends a message to NSE 180, the message is transmitted through NSE 170, and accordingly, the response of NSE 180 is transmitted through NSE 190 to host 160. For example, host 160 can be the same or similar to host 120 and NSEs 170, 180, 160 can be the same or similar to NSE 130.

FIG. 1E show exemplary configuration of a host and a plurality of peripheral devices. In this particular configuration, host 160 is connected to NSEs 170, 180, 190 through a serial cascade separate request and response busses. This configuration allows a host 160 to transmit a request through a bus to the NSEs 170, 180, 190, and the NSEs 170, 180, 190 provide a response back to the host without having to transmit the response through each of the NSEs. In this particular configuration, if host 160 sends a message to NSE 180, the message is transmitted through NSE 170, and accordingly, the response of NSE 180 is transmitted back through NSE 170 to host 160. For example, host 160 can be the same or similar to host 120 and NSEs 170, 180, 190 can be the same or similar to NSE 130.

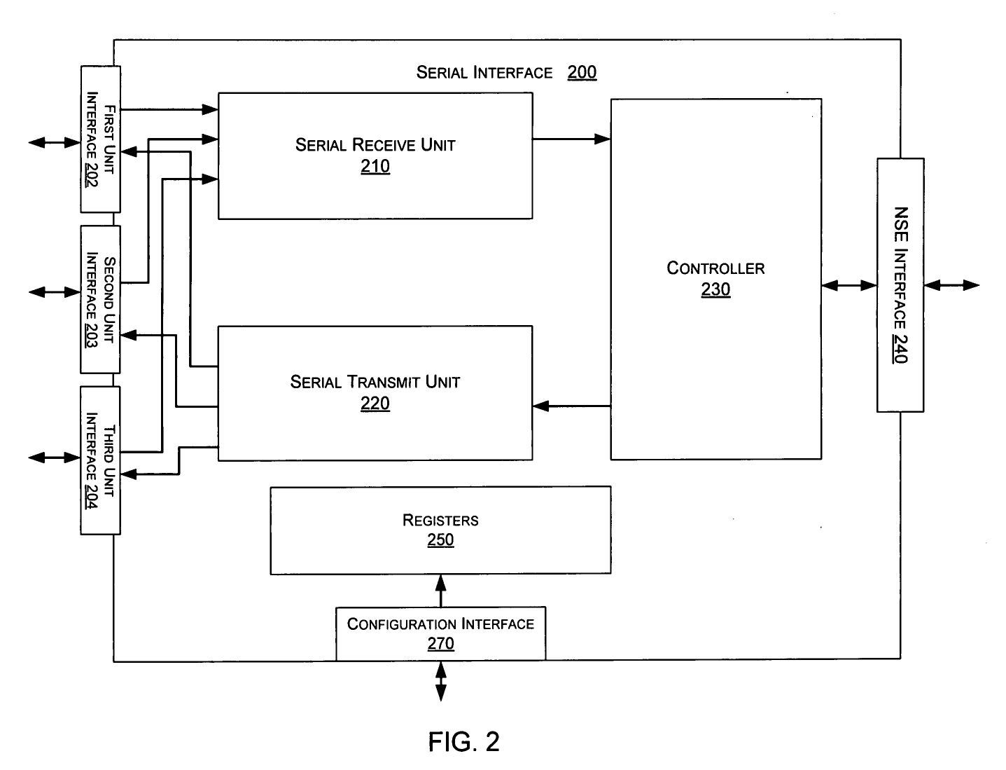

FIG. 2 is a block diagram illustrating an exemplary serial interface. Serial interface 200 can be located within an NSE or located as a standalone device in communication between a host and the NSE (e.g., host 120 and NSE 130 of FIG. 1A). Serial interface 200 can include, among other things, one or more unit interfaces 202-204, a serial receive unit 210, a serial transmit unit 220, a controller 230, a search interface 240, registers 250, and configuration interface 270.

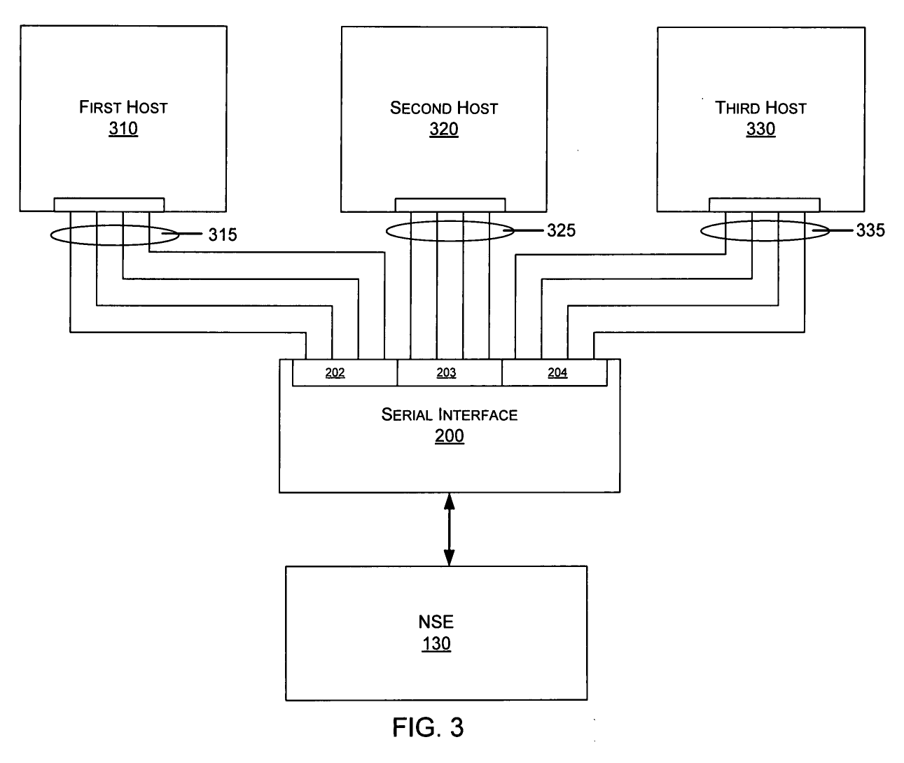

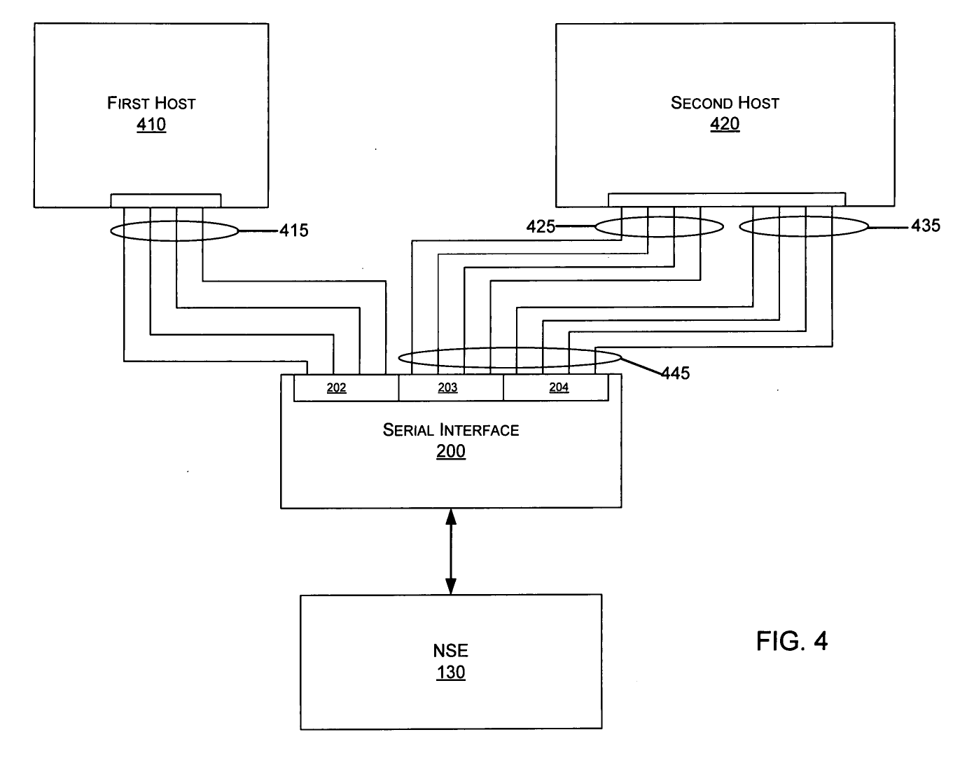

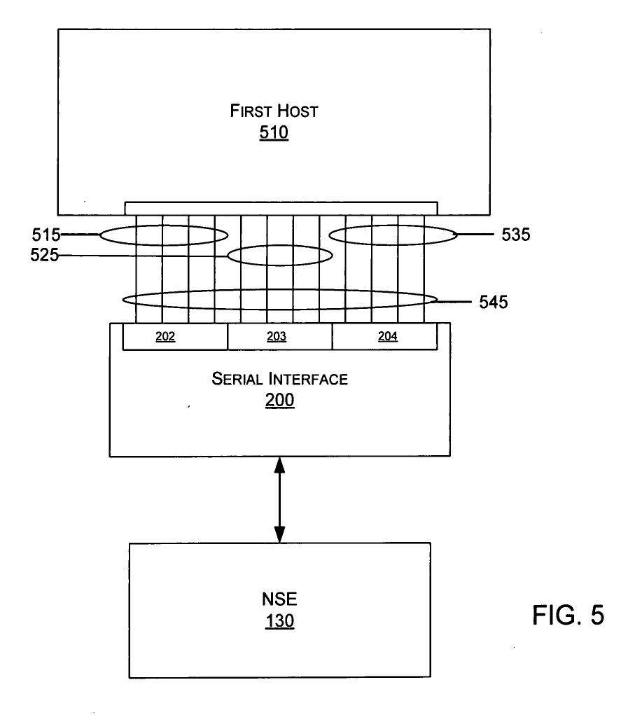

One or more unit interfaces 202-204 are interfaces that communicatively couple a host device (e.g., ASIC, FPGA, or a network processor) to serial interface 200. For example, unit interfaces 202-204 can each be a 10 Gbits/s attachment unit interface (XAUI; IEEE 802.3ae standard) or a Common Electrical Interface (CEI; Network Processing Forum standard), which operates at speeds of 3.125 Gbits/s and up to 11 Gbits/s. The XAUI is a standard for connecting 10 Gigabit Ethernet ports to each other and to other electronic devices. Unit interfaces 202-204 can be connected to a single host or different hosts, as will be described below in FIGS. 3, 4, & 5, through serial lanes. Each of the lanes can use the striping protocol by providing a byte of information across each lane during a bytetime, the time that it takes to send a byte of information across each lane. A set of lanes can include a number of lanes (e.g., four serial lanes) that can work together to provide the communicated data. During a bytetime, a set of lanes having four serial lanes would transmit 32 bits of data per bytetime (4 serials lanes*8 bits of data per lane). If there is a 64 bit message to be transmitted from host 120 to serial interface 200 through the four serial lanes, it would take two bytetimes to transmit the entire message. Further, based on commands from controller 230, unit interfaces 202-204 can be configured based on the total number of hosts and the hosts' connection to unit interfaces 202-204. This configuration can bond the multiple entities, each entity including a unit interface, together so that the multiple entities can work as a single entity instead of multiple entities. Furthermore, each unit interface deskews the four lanes and then the bonding can be used to correct the skew between the unit interfaces 202-204 thereby synchronizing the communications between serial interface 200 and the one or more hosts. While three unit interfaces 202-204 have been provided in this exemplary embodiment, any number of unit interfaces and their corresponding set of lanes can be provided on serial interface 200.

Serial receive unit 210 is a hardware device and/or software component that receives request data from the one or more unit interfaces 202-204 and formats the data so that controller 230 and later the NSE can understand the data.

Serial transmit unit 220 is a hardware device and/or software component that receives response data from controller 230, formats the response data, and provides the formatted response data to the one or more unit interfaces 202-204.

Controller 230 is a hardware device and/or software component that has the ability to configure the communicative aspects of the serial interface 200 to maximize one or more hosts' searching needs by bonding multiple entities to act as a single entity. In some embodiments, controller 230 can be programmed to bond certain entities together to act as a single entity. For example, if controller 230 determines that only one host is connected to unit interfaces 202-204 through three sets of lanes of data, controller 230 can bond the multiple entities to allow unit interfaces 202-204 to act as a single entity that receives data from a single entity of 12 lanes of data instead of three separate sets of four lanes. Further, if controller 230 determines that two hosts are connected to serial interface 200, controller 230 can determine which unit interfaces 202-204 are connected to the hosts. For example, if unit interfaces 202, 203 are connected to a first host and unit interface 204 is connected to a second host, controller 230 can configure unit interfaces to maximize the searching needs by bonding unit interfaces 202, 203, each having four lanes of data, to act as a single entity of 8 lanes while still allowing a second host to communicate to unit interface 204 using the remaining set of four lanes. In some embodiments, instead of controller 230 bonding the multiple entities, the serial receive unit 210, the serial transmit unit 220, and/or the configuration interface 270 can be used to bond the multiple entities together. For example, configuration interface 270 can be configured by setting a pin, which updates the registers 250 to inform two or more unit interfaces 202-204 to work together as a single entity.

Search interface 240 is an interface that communicatively couples the NSE with controller 230. For example, search interface 240 can be an 72 or 80 bit wide parallel interface that can be connected to the NSE. Search interface 240 can allow controller 230 and the NSE to communicate request data, clock/control data, and response data. Further, search interface 240 can be used on TCAM-based and algorithmic based search engines or on a memory device. For example, search interface 240 can be the Integrated Device Technology 75K72100.

Configuration interface 270 is a hardware device and/or software component that has the ability to configure the communicative aspects of the serial interface 200 to maximize one or more hosts' searching needs by bonding multiple entities to act as a single entity. As stated above, configuration interface 270 can be configured by setting a pin, which updates the registers 250 to inform the two or more unit interfaces 202-204 to work together as a single entity. In some embodiments, configuration interface 270 can be eliminated from the serial interface 200.

FIGS. 3, 4, & 5 illustrate exemplary embodiments of coupling one or more hosts to a serial interface of a network search engine. FIG. 3 illustrates three host devices 310, 320, 330 coupled to unit interfaces, 202, 203, 204, respectively, of serial interface 200, which further communicates with NSE 130. Please note that while three unit interfaces are shown, any number of unit interfaces can be placed on serial interface 200 to communicate with the host devices.

To enable communication between first host 310 and unit interface 202 of serial interface 200, a first set of serial lanes 315 are provided. In this particular example, first set of serial lanes 315 are four serial lanes that allow the ability to transmit a byte of data across each lane during each bytetime (a technique commonly referred to as striping). For example, for a 192 bit transmission having a 32 bit header and 160 bit message, it would take six bytetimes to complete the message across the four serial lanes as shown below:

$$6 bytetimes = \frac{192 bits}{4 lanes * 1 byte / ( lane * bytetime ) * 8 bits / byte}$$

Second host 320 and third host 330 perform the same or similarly to first host 310 by using the second set of serial lanes 325 and the third set of serial lanes 335, respectively, to communicate to unit interfaces 203-204 of serial interface 200.

FIG. 4 illustrates two host devices 410, 420 coupled to unit interfaces 202-204 of serial interface 200, which further communicates with NSE 130. In this exemplary embodiment, first host 410 is connected to first unit interface 202 through first set of serial lanes 415 and second host 420 is connected to second unit interface 203 and third unit interface 204 through a second set of serial lanes 425 and a third set of serial lanes 435, respectively. In this particular embodiment, each set of serial lanes has 4 lanes but any number of lanes could be used for each set.

Once the serial interface detects that a single host, such as second host 420, is connected to two or more unit interfaces, it can reconfigure the unit interfaces 203-204 to bond together to form a single entity that communicates using a single entity of 8 serial lanes 445 for a single communication instead of using two separate sets of serial lanes 425, 435. The advantage of bonding the second set of serial lanes 425 with the third set of serial lanes 435 into a single entity of 8 lanes 445 is that two subsequent messages can be handled differently by the single entity of 8-lanes. In the first scenario where two separate sets of serial lanes are used, if a first message is longer than the second message, the second message may be completely received at unit interface prior to the first message being completely received at another unit interface. For example, if the first message is 192 bits, it will take 6 bytetimes for second unit interface 203 to receive the complete first message. If the second message is 128 bits, it will take 4 bytetimes for the third unit interface 204 to receive the complete second message. The second host 420 would start transmitting the first message to the unit interface; one bytetime later after beginning the transmission of first message over second set of serial lanes 425, the second host 420 would start transmitting the second message over the third set of serial lanes 435. Because of the difference in bytetimes between the first message and the second message, the second message would complete first at the serial interface and the first message would complete last. Thus, serial interface 200 would have to reorganize the messages so that the first message would be first and the second message would be second so that the correct order of messages would be provided to NSE 130. To keep the messages in the proper order, a sequence number would be carried within each message, wherein this sequence number would consume bandwidth.

In the second scenario, where a single entity of 8 lanes 445 are utilized instead of the two sets of serial lanes 425, 435, the entire first message can be transmitted prior to transmitting the second message because the unit interfaces 203-204 have been configured to work together. For example, if the first message is 192 bits, it can take 3 bytetimes (due to the double in lanes) for the unit interfaces 203,204 to receive the complete first message. If the second message is 128 bits, it can take 2 bytetimes for the unit interface to receive the complete second message. Because the messages are received in the order that they are transmitted, serial interface 200 would not have to reorganize the messages from second host 420.

FIG. 5 illustrates one host device 510 coupled to unit interfaces 202-204 of serial interface 200, which further communicates with NSE 130. In this exemplary embodiment, first host 510 is connected to first, second, and third unit interface 202-204 of serial interface via first set of serial lanes 515, second set of serial lanes 525, and third set of serial lanes 535. Once serial interface 200 detects that a single host, such as first host 520, is connected to the first, second, and third unit interfaces 202-204, it can reconfigure the unit interfaces 202-204 to communicate using the single entity of 12 lanes 545 for a single communication instead of three separate groups of 4 serial lanes 515, 525, 535. As described in FIG. 4 above, the advantage of bonding the multiple sets of serial lanes into a single entity of 12 serial lanes 545 is that three subsequent messages can be handled by the single entity of 12 serial lanes in the order that the messages are received instead of the first message being transmitted using a first set of serial lanes, the second message being transmitted by a second set of serial lanes, and the third message being transmitted by a third set of serial lanes; the three separate transmittals sometimes requiring the serial interface 200 to reorganize the received messages before providing the message data to the NSE 130.

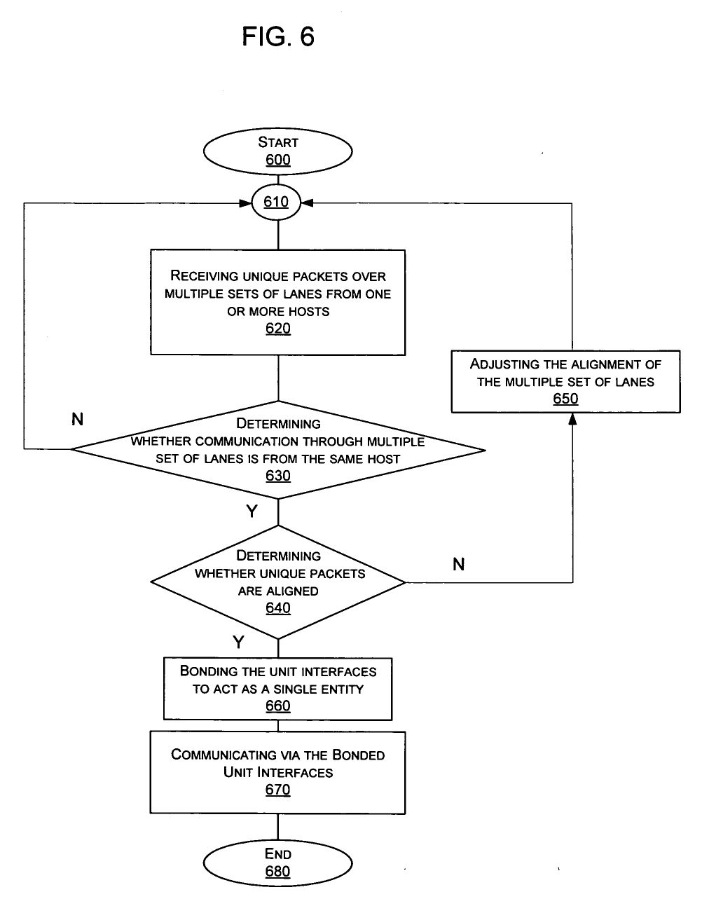

FIG. 6 illustrates a flowchart providing an exemplary method for configuring the serial interface. Referring to FIG. 6, it will be readily appreciated by one of ordinary skill in the art that the illustrated procedure can be altered to delete steps, move steps within the flowchart, or further include additional steps. In this exemplary embodiment, it is assumed that each lane of a set of serial lanes has been deskewed and aligned so that the all lanes of the set of serial lanes act as a single unit. Further, while the serial interface has the capability to configure itself, as provided below, it is readily appreciated by one of ordinary skill in the art that the serial interface can be configured, via pins on a configuration interface, to bond unit interfaces to act as a single entity based on information provided to the configuration interface on how the set of lanes are arranged.

After initial start step 600, serial interface receives in step 620 a unique packet data across each set of serial lanes from the one or more hosts. This unique packet can include data that identifies the host that provided the unique packet and synchronization data that helps determine whether the multiple sets of serial lanes are synchronized. Each serial interface can receive the unique packet from the host and provide a unique response packet, corresponding to the unique packet, back to the host.

Once the serial interface receives the unique packets, the serial interface can determine in step 630 whether the multiple entities correspond to a same host. For example, each of the multiple entities can include a unit interface and/or a corresponding set of serial lanes. In some embodiments, a single host can provide communications, such as the unique packets, over a first set of serial lanes (e.g., four serial lanes) and a second set of serial lanes to a first unit interface and a second unit interface respectively. This communication can include data that identifies the host so the serial interface can determine whether multiple entities are receiving communications from the same host. If not, the method can proceed to connector 610. In some embodiments, determining step 630 can be switched with determining step 640.

If multiple entities correspond to the same host, the serial interface can determine in step 640 whether the received unique packets are aligned across the combination of the multiple sets of serial lanes (e.g., first set of serial lanes and the second set of serial lanes). For example, the serial interface can provide different methods for aligning the multiple sets of serial lanes. In some embodiments, such as a single step method, the host can transmit alignment data through each of the lanes where the serial interface aligns each of the lanes to the other lanes for purposes of synchronizing the data transmitted across the lanes and unifying the unit interfaces.

In some embodiments, such as a multi-step method, the serial interfaces align the multiple sets of serial lanes by synchronizing each set of serial lanes independently. Because the first set of lanes have been synchronized and the second set of lanes have been synchronized independently of each other, the serial interface can adjust the alignment of the first set of serial lanes with the second set of serial lanes so that they can be eventually bonded together and work as a single entity. If three or more sets of lanes are to be aligned, the multi-step method can synchronize each set of lanes and either align the sets of lanes all at once or align a first set of serial lanes with a second set of serial lanes and subsequently align the third set of serial lanes with the aligned first-second sets of serial lanes, etc.

If the unique request packets are not aligned, the serial interface can adjust in step 650 the alignment of the multiple entities and the method can proceed to connector 610 where the serial interface can further determine whether the adjustment aligned the first set of lanes with the second set of lanes.

On the other hand, if the unique request packets are aligned across the combination of the first set of serial lanes and the second set of serial lanes, serial interface bonds in step 660 the first set of serial lanes with the second set of serial lanes to act as a single entity. As a result, in some embodiments, the serial interface can notify the host that the multiple set of lanes are aligned together to bond a single entity. Once the packets of the bonded lanes are determined to be aligned by the serial interface, the serial interface communicates in step 670 with the host using the bonded interfaces, wherein the communication is synchronized and aligned. Further, the serial interface has the ability to occasionally transmit unique response packets to the host to determine if the lanes are still aligned with each other. Once the serial interface has bonded the multiple entities to act as a single entity, the method can proceed to end in step 680.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A serial interface comprising:
a controller; and
multiple unit interfaces that communicatively couple the controller with at least one host, wherein a set of lanes couples each unit interface communicates with the host,
wherein the controller bonds two or more unit interfaces to function as a single entity when the two or more unit interfaces communicate with a single host.

2. The apparatus of claim 1, further comprising a search engine interface that communicatively couples the controller to a network search engine.

3. A method comprising:
receiving packets through multiple unit interfaces over multiple set of lanes from at least one host, wherein each unit interface corresponds to a single set of lanes;
determining whether the received packets are aligned; and
bonding multiple unit interfaces to function as a single entity based on the determination and whether the received packets received through the multiple set of lanes corresponding to the multiple unit interfaces are from a single host.

4. The method of claim 3, further comprising adjusting the alignment of the multiple unit interfaces based on the determination that the received packets are not aligned.

5. The method of claim 4, further comprising
transmitting subsequent response packets through multiple unit interfaces over multiple set of lanes to at the at least one host;
receiving subsequent packets through the multiple set of lanes from the at least one host; and
determining whether the subsequent packets are aligned for bonding the multiple unit interfaces.

6. A system comprising:
at least one host;
a network search engine; and
a serial interface configured to translate the data communicated between the host and the network search engine, the serial interface comprising:
a controller; and
multiple unit interfaces that communicatively couple the controller with at least one host, wherein a set of lanes couples each unit interface with a host,
wherein the controller bonds two or more unit interfaces to function as a single entity when the two or more unit interfaces communicate with a single host.

7. A serial interface comprising:
a controller;
a first unit interface that communicatively couples the controller with a host, wherein the first unit interface communicates with the host through a first set of lanes; and
a second unit interface that communicatively couples the controller with the host, wherein the second unit interface communicates with the host through a second set of lanes,
wherein the controller bonds the first unit interface and the second unit interface to function as a single entity for communicating with the host.

8. The serial interface of claim 7, wherein the controller bonds the first unit interface and the second unit interface based on communication with a configuration interface.

9. The serial interface of claim 7, wherein the controller bonds the first unit interface and the second unit interface based on communication with a serial receive unit.
